(19) United States
(12) Patent Application Publication
(10) Pub. No.: US 2025/0111010 A1
(43) Pub. Date: Apr. 3, 2025

(54) LIGHT MATRIX PROCESSING APPARATUS BASED ON MATRIX IMAGE SENSOR AND LIGHT-EMITTING DISPLAY

(71) Applicant: Dmitri Pescianschi, Quedlinburg (DE)

(72) Inventor: Dmitri Pescianschi, Quedlinburg (DE)

(21) Appl. No.: 18/901,779

(22) Filed: Sep. 30, 2024

Related U.S. Application Data
(60) Provisional application No. 63/541,013, filed on Sep. 28, 2023.

(51) Int. Cl. G06F 17/16; G09G 3/32; G09G 3/3225; G09G 3/36; H04N 25/76

(52) U.S. Cl. CPC G06F 17/16; G09G 3/32; G09G 3/3225; G09G 3/3648; H04N 25/76; G09G 2320/0626

(57) ABSTRACT

An apparatus performing matrix calculations by using a matrix image sensor, for example, a CMOS image sensor, for calculations. The apparatus further includes a light-emitting display, for example, AMOLED, as a matrix memory register. In the apparatus, each emitting pixel encodes the value of one matrix element.

### CROSS-REFERENCE TO RELATED APPLICATIONS

This application claims all rights of priority to U.S. Provisional Patent Application No. 63/541,013, filed on Sep. 28, 2023 (pending).

### FIELD OF INVENTION

The invention relates to the field of electronics, microelectronics, optoelectronics, information processing and conversion.

### BACKGROUND OF THE INVENTION

Photodetector arrays are traditionally used as Matrix Image Sensors. In turn, arrays of light emitters, such as OLED or QLED, are traditionally used as displays. At the same time, one of the key features of both radiating and sensory matrices is the potential parallelism and independence of both radiating and sensory cells (pixels). The most common type of Matrix Image Sensors is CMOS image sensor, shown in FIG. 1.

The light image falls simultaneously on all pixels of the Matrix Image Sensor. All Pixel Photo-detectors convert the light intensity in parallel into an electrical signal corresponding to the intensity. The signal is amplified by the Pixel Amplifier. To read the signal values of all pixels, rows (R1, R2, . . . . Rn) are sequentially selected and columns (C1, C2, . . . . Cm) are sequentially selected. The amplified signal from the pixel addressed by the selected row and column is digitized at the ADC and sent to the output. Thus, the CMOS image sensor processes light signals in parallel, but sequentially delivers the result to the output.

Photo-detector CMOS-element may have a different device, but they necessarily contain photodiodes as a light sensor, transistors as a signal amplifier, a line selection bus, a bus through which the signal is transmitted to the processor and an amplifier power bus. A typical diagram of a Photo-detector CMOS-element is shown in FIG. 2.

The most common type of light emitting display is an active array LED (AM LED). For example, AMOLED. A typical example of an LED pixel is shown in FIG. 3. An AMOLED matrix is built from LED cells and is shown in FIG. 4.

### SUMMARY

In its general aspect, the invention is an apparatus performing matrix calculations by using a matrix image sensor, for example, a CMOS image sensor, for calculations. The apparatus further includes a light-emitting display, for example, AMOLED, as a matrix memory register. In the apparatus, each emitting pixel encodes the value of one matrix element.

### BRIEF DESCRIPTION OF THE DRAWINGS

The invention is illustrated by way of examples which are not a limitation, and the figures of the accompanying drawings in which references denote corresponding parts, and in which:

FIG. 1 shows schematics of a traditional CMOS image sensor;

FIG. 2 shows a prior art circuit diagram of a CMOS cell;

FIG. 3 shows a prior art circuit diagram of an AMOLED cell;

FIG. 4 shows schematics of an AMOLED matrix;

FIG. 5 shows LMPU schematics of a CMOS image sensor;

FIG. 6 shows a formula corresponding to the processes of the CMOS image sensor of FIG. 5;

FIG. 7 shows transformed schematics of a CMOS image sensor chip in accordance with the present invention; and

FIG. 8 shows transformed schematics of an AMOLED matrix in accordance with the present invention.

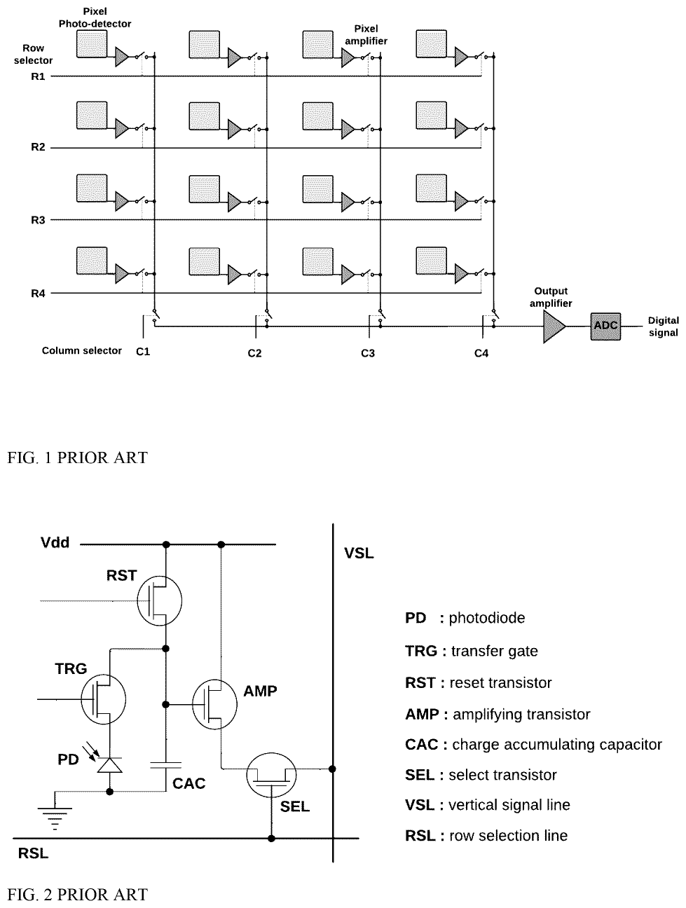

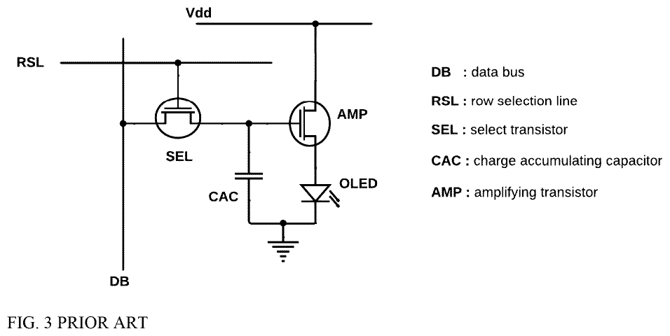

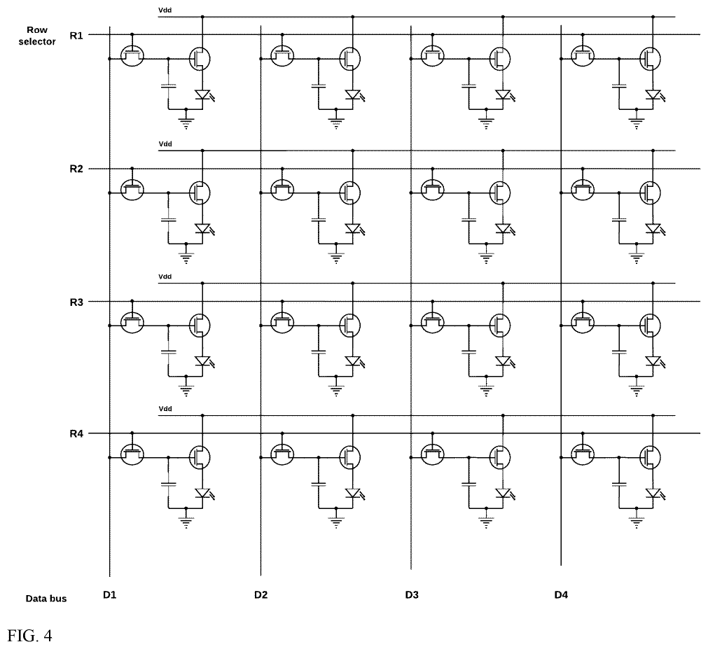

### DESCRIPTION OF THE INVENTION

Using a combination of light-emitting displays and matrix image sensors, a new device is constructed for performing matrix calculations. Since the Amplifying Transistor (AMP) acts as a resistance (R) controlled by the voltage applied to the base of the transistor, and Ohm's law applies to it,

$$I = \frac{x}{R} ,$$

where x is the voltage applied to the collector of the AMP. Moreover, the resistance R is inversely proportional to the voltage applied to the base of the transistor. On the other hand, the voltage applied to the AMP base is directly dependent on the intensity of the light flux incident on the photodiode. Thus, with a certain approximation, the current strength at the emitter of the transistor AMP is I=ωx, where ω is a function of the light flux incident on the photodiode, and x is the voltage applied to the AMP collector. In this regard, AMP, which amplifies the signal from the CMOS image sensor photodiode, can be interpreted as an analog device that multiplies two parameters, one of which is the light signal on the photodiode, and the second is an electrical signal that amplifies the signal from the photodiode.

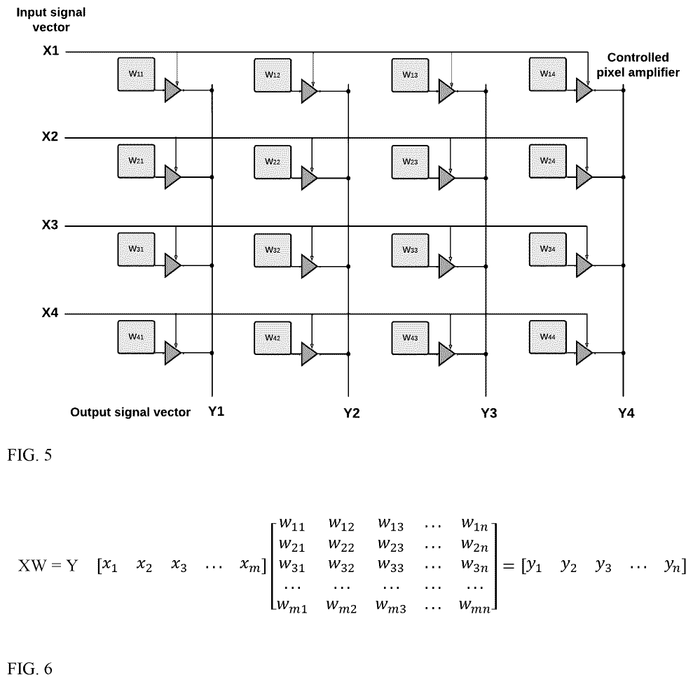

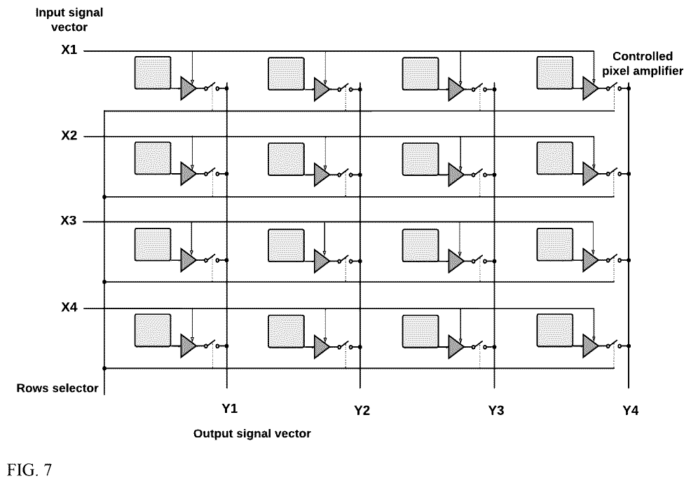

Thus, when amplifying transistors are used as controlled amplifiers, and signals from all photodiodes are read in parallel, and the emitters of amplifying transistors are connected in parallel in circuits, the currents on which are summed, this results in a device for analog multiplication of the vector X voltages (xᵢ), that control signal amplifiers from photodiodes, on the photodiode signals themselves (wᵢⱼ). The output is a vector of output signals (yⱼ), as shown in FIGS. 5 and 6

In this case, the matrix of light signals (W) is formed on a light-emitting matrix display, for example, AMOLED, each emitting pixel of which is combined with the corresponding photodiode pixel of Matrix Image Sensors. Thus, the weight matrix (W) is a simple light image on the display.

As shown in FIG. 7, the apparatus above can utilize photo-matrix chips as a CMOS image sensor, in which the power supply of amplifying transistors is divided into circuits (rows) with common inputs only for the circuit, but not for all amplifying transistors; row selectors are closed to each other, which ensures that all rows are connected at the same time; discarded speaker selectors, output circuit with output amplifier and ADC. Analog output signals are taken in parallel.

The apparatus described above can utilize an AM LED or AM LCD as the light emitting display. If AM LED is utilized, the LED display is preferably equipped with resistive or other pixel memory as a light-emitting display. Similarly, if AM LCD is utilized, the LCD is preferably equipped with resistive or other pixel memory as a light-emitting display.

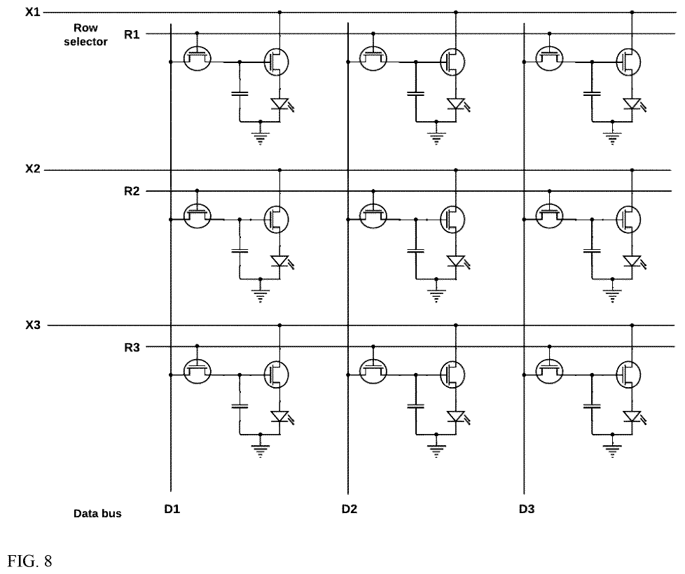

Finally, the apparatus using AM LED light emitting display includes a learning function, as illustrated in FIG. 8.

For training, that is, adjusting the brightness of the pixels, the power circuits (xᵢ) of the amplifying transistors (AMP) of the LEDs are supplied with voltages depending on the input signals of the X voltage vector (xᵢ) of the CMOS image sensor, and the Data bus (Dⱼ) circuits are supplied with voltages depending on the level of errors at the outputs of the CMOS image sensor, moreover, in such a way that the amplification of the signal on the AMP corrects the brightness of the LEDs, reducing the overall error at the outputs of the CMOS image sensor. Then the CMOS image sensor is launched in the mode of operation of an ordinary photomatrix and takes the brightness values of each LED. The obtained values form a new adjusted (trained) memory of the LED matrix.

The above apparatus of preferably utilizes an AM LED as a light emitting display with pixel resistive memory. In this case, the brightness adjustment is made directly on the resistances with memory. This eliminates the need for the step of measuring the brightness values of the LEDs using the CMOS image sensor.

Alternatively, the above apparatus can utilize an AM LCD as the light emitting display with learning function. For training, that is, adjusting the brightness of the pixels, the LCD is illuminated not with uniform light, but with LED circuits that are uniformly bright only for circuits perpendicular to the output circuits of the CMOS image sensor, and whose brightness depends on the input signals of the X voltage vector (xᵢ) of the CMOS image sensor, and voltages are applied to the Data bus (Dⱼ) circuits, depending on the level of errors at the outputs of the CMOS image sensor, moreover, in such a way that changing the transparency of the pixels of liquid crystals reduces the overall error at the outputs of the CMOS image sensor. Then the CMOS image sensor is launched in the mode of operation of an ordinary photomatrix and takes the transparency values of each pixel of liquid crystals. The obtained values form a new adjusted (trained) memory of the LCD matrix.

Further, the above apparatus can utilize the AM LCD with pixel resistive memory as the light emitting display. In this case, the brightness adjustment is made directly on the resistances with memory. This eliminates the need for the step of measuring the transparency values of the LEDs using the CMOS image sensor.

In the preceding specification, the invention has been described with reference to specific exemplary embodiments thereof. It will however, be evident that various modifications and changes may be made thereto without departing from the broader spirit and scope of the invention as set forth in the claims that follow. The specification and drawings are accordingly to be regarded in an illustrative manner rather than a restrictive sense.

1. An apparatus performing matrix calculations, the apparatus comprising:
a matrix image sensor performing calculations; and
a light-emitting display as a matrix memory register,
wherein each emitting pixel encodes the value of one matrix element

2. The apparatus of claim 1, wherein said matrix image sensor is a CMOS image sensor.

3. The apparatus of claim 1, wherein said light-emitting display AMOLED.

4. The apparatus of claim 1, wherein said light-emitting display is an AM LED.

5. The apparatus of claim 1, wherein said light-emitting display is an AM LCD.

6. The apparatus of claim 1 further comprising means for learning and training.
